(19) United States
(12) Patent Application Publication
(10) Pub. No.: US 2025/0244018 A1
(43) Pub. Date: Jul. 31, 2025

(54) GRILLING APPARATUS WITH VARIABLE HEIGHT TRAY FEATURE

(71) Applicant: Chris Blackwood, Phoenix, AZ (US)

(72) Inventor: Chris Blackwood, Phoenix, AZ (US)

(21) Appl. No.: 18/429,211

(22) Filed: Jan. 31, 2024

(51) Int. Cl. F24B 13/02; A47J 37/07; F24B 3/00

(52) U.S. Cl. CPC F24B 13/02; A47J 37/0704; A47J 37/0786; F24B 3/00

(57) ABSTRACT

The present disclosure introduces a grilling apparatus featuring a lifting mechanism that enables vertical adjustment of a heat source heat tray within the grill body. The lifting mechanism allows the user to alter the proximity of the heat source to the food grate, thereby enabling control over the cooking temperature. The embodiments of the present disclosure improve the grilling process by taking advantage of the distinct flavor profile afforded by solid fuels and offering convenient temperature control. The lifting mechanism is configured to maintain the heat tray in a level position during height adjustments, providing a stable and consistent heat distribution.

The present invention relates to the field of cooking appliances and, more specifically, to grilling equipment.

### BACKGROUND

Grilling is a versatile cooking technique that can be used for a wide range of foods, including meats, vegetables, and even fruits, providing a smoky flavor that is highly sought after by culinary enthusiasts.

A grill is a cooking device designed to apply heat from below to cook food. The basic components of a grill include a cooking surface, commonly referred to as a grate or grid, and a heat source or burners that generate the required heat for cooking.

### BRIEF SUMMARY

The present disclosure relates to a grilling apparatus designed to enhance the control and convenience of cooking by allowing for the adjustment of the heat source's proximity to the food being grilled. The grilling apparatus comprises a grill body that forms the main structure of the grilling apparatus, within which a cavity is formed by one or more surfaces of the grill body. This cavity is specifically shaped to accommodate a heat tray, which is used to contain a heat source such as charcoal or wood chips.

The grilling apparatus includes a lifting mechanism that is coupled to the heat tray. The lifting mechanism enables the vertical adjustment of the heat tray's position within the cavity, allowing the user to regulate the intensity of heat applied to the food. The lifting mechanism includes a handle that is designed to receive a rotational force applied by the user. This rotational force is then converted to a vertical force, adjusting the position of the heat tray, thus adjusting the distance between the heat source and the food. By providing this adjustable mechanism, the grilling apparatus offers a versatile cooking experience, allowing for a range of grilling techniques from searing to slow roasting.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an exploded view of the grilling apparatus illustrating selected components, according to some examples.

FIG. 2 is a front-left perspective view of the grilling apparatus, according to some examples.

FIG. 3 is an exploded view of the grilling apparatus, illustrating an alternate view of selected components, according to some examples.

FIG. 4 is a cutaway view of the grilling apparatus, according to some examples.

FIG. 5 is a side perspective view of the grilling apparatus, according to some examples.

### DETAILED DESCRIPTION

Gas grills offer precise temperature control through the adjustment of fuel flow to the burners. In contrast, grills utilizing solid fuels such as charcoal or wood present a challenge in temperature regulation due to the static nature of the burning material. The operator of a grill utilizing solid fuels must often resort to manual repositioning of the cooking surface or the fuel to achieve the desired heat level, a method that lacks finesse and can introduce variability in the cooking process.

The embodiments described herein overcome this limitation by incorporating a mechanical system that permits the vertical adjustment of the heat source heat tray. The system enables the user to adjust the proximity of the heat source to the food, enabling fine-tuning of the cooking temperature without the need for modulation of an intensity of the heat source through regulation of a fuel supply of the heat source. The embodiments of the present disclosure improve the grilling process by taking advantage of the distinct flavor profile afforded by solid fuels and offering convenient temperature control.

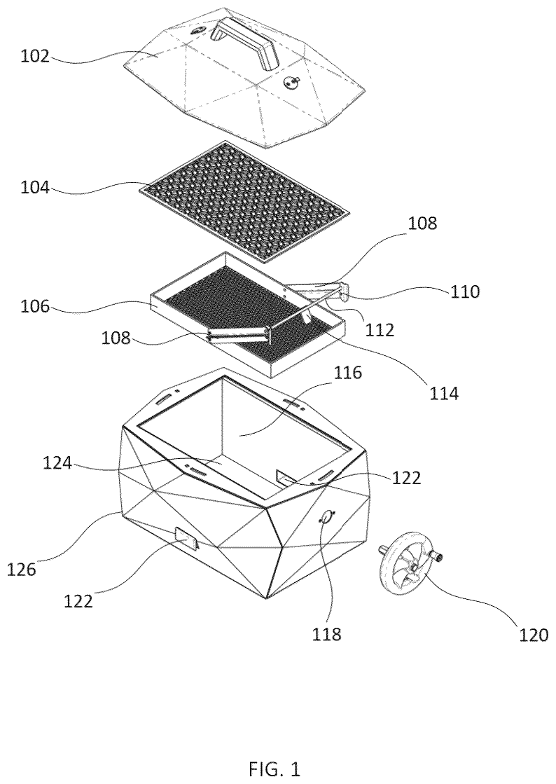

FIG. 1 is an exploded view of the grilling apparatus, according to some examples. The grilling apparatus (e.g., a grill, barbeque grill) may include a lid 102 (e.g., an insulated cover), a food grate 104, a heat tray 106, at least one lever arm 108, one or more hinge 110, a rod 112, a push tab 114, a heat box 116, a pass-through 118, a turning knob 120, one or more bottom vents 122, a cavity 124, and a grill body 126.

The lid 102 is the top component of the grilling apparatus, designed to cover the grilling apparatus and retain heat for cooking, by providing a thermally efficient enclosure to maintain a consistent and controlled temperature for effective grilling or smoking. The lid 102 can be opened or removed to access the interior or closed to maintain the desired cooking environment. In some examples, the lid 102's design may reflect the aesthetic of the grill body's exterior. In some examples, the grilling apparatus may be operated without a lid 102.

The food grate 104 is the surface on which the food is placed for grilling. The food grate 104 is made of a material that can withstand high temperatures and allows for the easy flow of heat and smoke around the food, contributing to the grilled flavor and appearance. In some examples, the design of the food grate 104 features a pattern of parallel bars (e.g., stripes) with gaps in between, allowing heat to rise directly from the heat source and smoke to circulate freely, enveloping the food. The pattern also transfers grill marks matching the pattern of parallel bars on the food as the grilling apparatus cooks, making the food more visually enticing.

The heat tray 106 is positioned below the food grate 104. The heat tray 106 holds the primary heat source, such as charcoal, wood chips, and other solid fuel. The heat tray 106's position can be adjusted to control the cooking temperature, enabling the operator to achieve desired cooking results. When in the raised position, the heat source is situated closer to food grate 104, resulting in higher temperatures for cooking. Conversely, in the lowered position, the heat source is further away from food grate 104, yielding lower cooking temperatures. In some examples, the heat tray 106 comprises of a porous section at the bottom. The porous section allows for the ash and smaller remnants of the spent fuel to fall through into a bottom of the cavity 124 of the grilling apparatus, and the heat tray 106 may be removed after the grilling session, simplifying the cleaning process. The porous section of the heat tray 106 also enables air to flow better around the heat source for maintaining an even and consistent burn of the heat source. The heat tray 106 is made of materials that are strong and heat-resistant enough to support the weight and heat of the heat source.

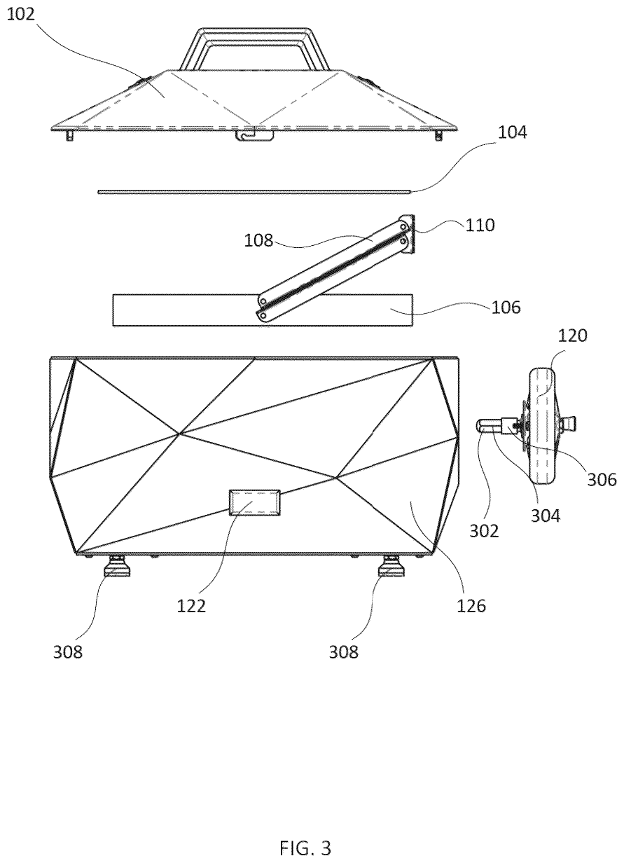

The at least one lever arm 108 is connected to the hinge 110 on a first end and connected to the heat tray 106 on a second end. Each of the at least one lever arm 108 is configured to adjust the positions of the heat tray 106 within the grill body 126. In some examples, each of the at least one lever arm 108 include an upper arm and a lower arm, allowing the heat tray 106 to be horizontally level. Further elaboration on the lever arm 108 is provided in the description to FIG. 3.

The hinge 110 are affixed to either the surfaces 402 of the grilling apparatus or the inner walls of the heat box 116. In some examples, the hinge 110 include two connection points, one coupled to the upper arm 404 of the lever arm 108, and the other coupled to the lower arm 406 of the lever arm 108. The hinge 110 and the lever arm 108 are joined in a manner that permits the lever arm 108 to pivot, enabling the raising and lowering of the heat tray 106. In some examples, the grilling apparatus includes a pair of hinge 110, each connected to a lever arm 108. Spanning between the pair of hinge 110 is a rod 112, which connects the pair of hinge 110.

The push tab 114 is a component of the lifting mechanism that interacts with the lever arm 108. Rotating the turning knob 120 applies a force to the push tab 114, which in turn actuates the lever arm 108, altering the vertical position of the heat tray 106. In some examples, the push tab 114 is connected to the lever arm 108 in such a way that exerting force on the push tab 114 concurrently moves the lever arm 108, causing them to pivot and elevate the heat tray 106. In some other examples, the push tab 114 is coupled to the rod 112, and as force is applied to the push tab 114, the push tab 114 may actuate the rod 112, causing the rod 112 to rotate, which in turn pivots the lever arms 108 to lift the heat tray 106. In some examples, the lifting mechanism may include a holding mechanism configured to maintain the position of the heat tray 106 when the force is released. For example, the turning knob 120 may include one or more dampers that provide resistance, thereby preventing the turning knob 120 from turning in the opposite direction under the influence of gravity. For another example, the holding mechanism is a ratchet mechanism that engages with the turning knob 120. This ratchet mechanism is designed to maintain the position of the heat tray 106 by preventing backward movement of the push tab 114 and lever arm 108 once the desired height is achieved. When the operator rotates the turning knob 120, the ratchet mechanism allows incremental movements of the push tab 114 and lever arm 108, locking into place after each adjustment. This ensures that the heat tray 106 remains securely at the set elevation, even when the operator's hand is removed from the turning knob 120. The ratchet mechanism includes a series of teeth and a pawl that engages the series of interlocking teeth to restrict motion in one direction. To lower the heat tray 106, the operator disengages the ratchet mechanism, allowing the push tab 114 to move backward and lever arm 108 to pivot in the opposite direction under the influence of gravity. For other examples, the holding mechanism may be one of a friction brake, a locking gear, a magnetic latch, or a detent mechanism, each providing sufficient resistance to maintain the heat tray 106 in the desired position until an intentional adjustment is made by the user.

The heat box 116 is a compartment within the cavity 124 that houses the heat tray 106. It is designed to focus heat towards the food grate 104, ensuring that the cooking temperature is maintained for grilling. In some examples, the heat box 116 provides support for the food grate 104 in a manner that allows the food grate 104 to be positioned on top of the heat box 116. The food grate 104 is designed with a surface area slightly larger than the pass-through of the heat box 116, enabling the food grate 104 to rest securely on top of the heat box 116. In some examples, the food grate 104 may be fastened to heat box 116 using one or more retaining tabs or retaining clips. The one or more retaining tabs or retaining clips may be engaged or disengaged with corresponding slots or catches on the heat box 116, providing a secure fit that prevents the food grate 104 from shifting during use, yet allows for easy removal when necessary for cleaning or adjusting the heat source.

The pass-through 118 in the grill body 126 provides access to the internal components of the grilling apparatus, such as the lever arm 108, the push tab 114, and other components of the lifting mechanism. The pass-through 118 allows interactions between the push tab 114 and the push shaft 302, enabling the transmission of force exerted on the turning knob 120 to the push tab 114. The interactions between the push tab 114 and the push shaft 302 allow the lifting and lowering of the heat tray 106 described above.

The turning knob 120 is configured to be operated by a user of the grilling apparatus. When the user rotates the knob, his or her action generates a rotational force that is conveyed to the push shaft 302. The push shaft 302 is configured to convert the rotational force into a linear force. The linear force is then applied to the push tab 114, which in turn facilitates the vertical adjustment of the heat tray 106. Therefore, by turning the turning knob 120, the user may alter the position of the heat tray 106, adjusting the cooking temperature. In some examples, the rotational force may be provided by a motor instead of manual input from the user.

The bottom vent 122 in the grill body allow air to enter grill body, providing oxygen to sustain the combustion of the solid fuel. In certain embodiments, the bottom vent 122 may include an adjustment provision for controlling airflow, which directly affects the intensity of the heat source.

In some embodiments, the adjustment provision may include a sliding mechanism, allowing for smooth and precise adjustments to the bottom vent 122's opening. For example, the sliding mechanism may comprise a panel that fits snugly against the grill body 126, and wherein the panel comprises a handle or tab, and the bottom vent 122 comprises one or more vent openings, such as a series of holes or slits. Accordingly, a user of the grilling apparatus may manipulate the sliding mechanism via the handle or tab, to slide the panel back and forth. The sliding mechanism may operate on a track or groove system such that when the user moves the handle, the panel slides along these tracks, aligning or misaligning the holes in the panel with the bottom vent 122. The movement of the sliding mechanism either increases or decreases the amount of air that can enter through the bottom vent 122.

In some examples, the bottom vent 122 comprises a circular (or semi-circular) passage, wherein the adjustment provision may include a rotary dial formed of a heat-resistant material. Rotation of the rotary dial may control the airflow. For example, the rotary dial may include a series of placed openings or perforations on the bottom vent 122. As the user rotates the dial, these openings align to varying degrees with the bottom vent 122, controlling the amount of air that can pass through.

In some examples, the adjustment provision comprises a hinged flap, where the hinged flap may be quickly lifted or lowered to alter the air passage, offering a method for heat regulation.

The cavity 124 is an interior space formed by one or more surfaces 402 of the grill body 126. The cavity 124 holds the space within the grill body 126 where the heat tray 106, the one or more lever arm 108, the hinge 110, the rod 112, the push tab 114, the heat box 116, and other internal components of the grilling apparatus are located.

The grill body 126 includes the one or more surfaces 402 and forms the overall structure of the grilling apparatus, providing support and stability for both internal and external components of the grilling apparatus. It defines the overall shape of the grilling apparatus.

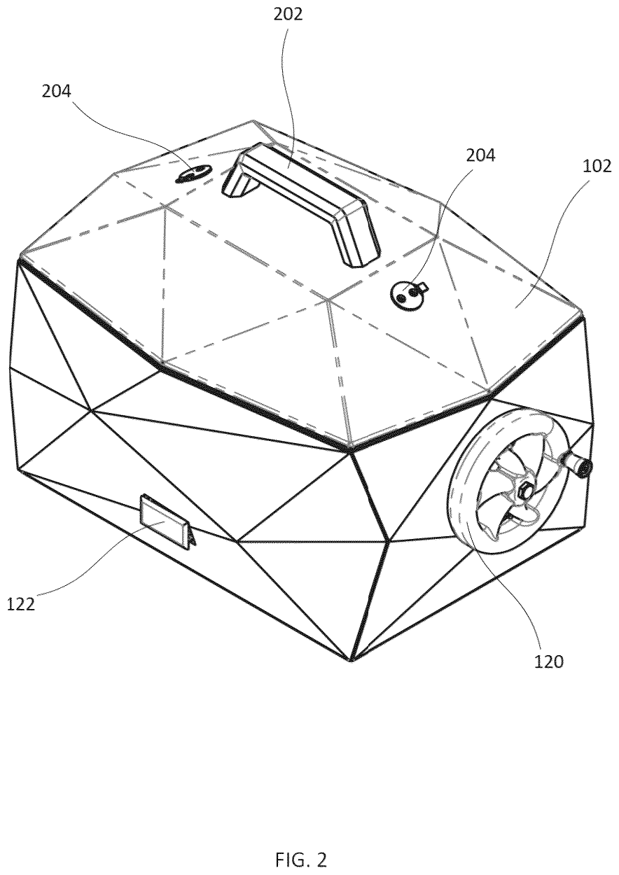

FIG. 2 is a perspective view of the grilling apparatus, according to some examples. The lid 102 further includes one or more handles 202 and one or more top vents 204.

The one or more handles 202, securely mounted on the lid 102, are configure to open and close the lid 102. The one or more handles may be constructed with insulating materials or are spaced sufficiently from the lid 102 to minimize heat transfer, protecting the user from the heat emanating from the lid 102 during operation.

The one or more top vents 204 situated on the lid 102 may be exhaust vents designed to facilitate the release of smoke and heat from within the grilling apparatus. In some examples, the top vents 204 comprise of one or more movable vent plates or louvers, each configured to pivot around an axis. The angles of the one or more movable vent plates or louvers may be adjusted to let more or less air into and/or out of the cavity, thereby fine-tuning the amount of air entering and/or exiting the grilling apparatus. In some examples, the adjustments to the top vents 204 affect the combustion rate of the heat source and/or the internal temperature of the grilling apparatus. By opening the top vents 204, the operator can increase the airflow, which increases the combustion rate of the temperature, thereby raising the temperature of the heat source for high-heat grilling or searing. Conversely, partially closing the vents restricts the airflow, which can lower the temperature for slow-cooking methods like smoking or barbecuing.

FIG. 3 is an exploded view of the grilling apparatus, illustrating an alternate view of selected components, according to some examples. FIG. 3 illustrates the lid 102, the food grate 104, the heat tray 106, the one or more lever arm 108, the hinge 110, the turning knob 120, one of the bottom vents 122, the grill body 126, a push shaft 302, and other unlabeled components. The push shaft 302 further includes a first portion 304 and a second portion 306.

The turning knob 120 may be placed on a surface of the grill body 126. In the example illustrated in FIG. 3, the turning knob 120 is installed on the left side of the grill body 126. In some examples, the grill body 126 includes one or more legs 308 at a base on the grill body 126, lengths of the one or more legs 308 are adjustable, thereby offering height adjustments to the grilling apparatus. In some examples, the one or more legs 308 are threaded bolts. By rotating the one or more legs 308, the protrusion of the one or more legs 308 from the base of the grilling apparatus may be adjusted, effectively altering the height of the grilling apparatus to accommodate various cooking conditions and user preferences. In some other examples, one or more legs 308 may involve telescopic sections or locking pin systems, allowing for smooth and continuous adjustments to the extent to which one or more legs 308 extend from the base of the grilling apparatus, thereby adjusting the height of the grilling apparatus.

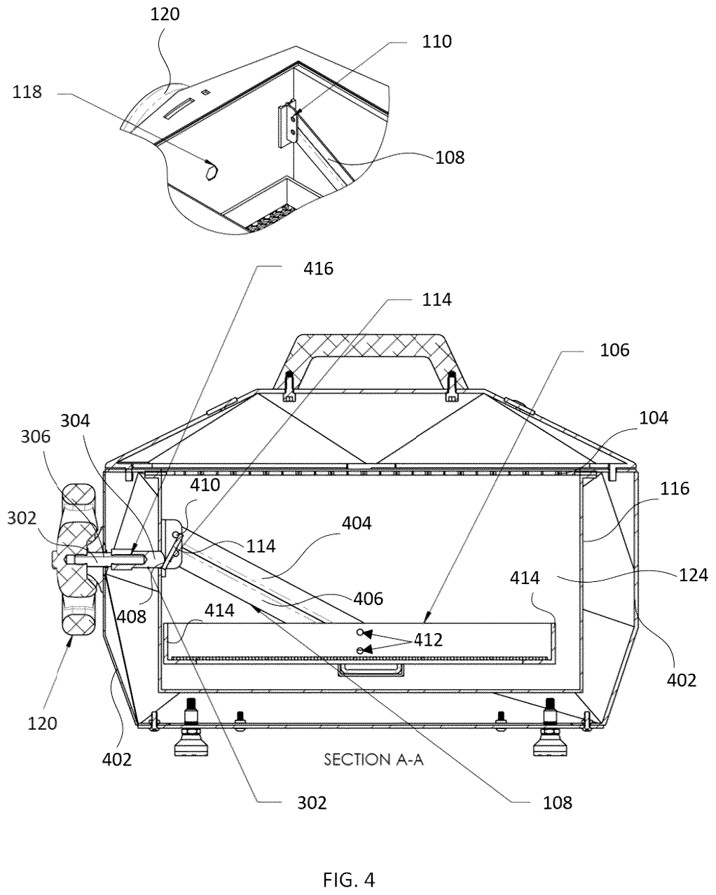

The turning knob 120 may be coupled to a push shaft 302 that converts the rotational force applied by the user into a linear force. In some examples, the push shaft 302 includes the first portion 304 and the second portion 306. The first portion 304 has exterior threads that correspond to interior threads on the second portion 306. The first portion 304 is configured to slide through the pass-through 118 but is prevented from rotating due to a cross-sectional shape of the first portion 304 is identical to that of the pass-through 118. In some examples, both the cross-sectional shape of the first portion 304 and the pass-through 118 have non-circular shapes. For example, both the cross-sectional shape of the first portion 304 and the pass-through 118 are hexagonal. The second portion 306 is coupled to the turning knob 120 and is configured to rotate with the turning knob 120. By rotating the second portion 306 relative to the fixed first portion 304, the overall length of the push shaft 302 may be adjusted, akin to an action of tightening or loosening a screw, thereby enabling the transformation of rotational force into linear force. More examples of the push shaft 302 are included in the description to FIG. 4.

FIG. 4 is a cutaway view of the grilling apparatus, according to some examples. In the example illustrated in FIG. 4, the grilling apparatus includes the food grate 104, the heat tray 106, the at least one lever arm 108, the hinge 110, the push tab 114, the heat box 116, the pass-through 118, the turning knob 120, the cavity 124, the push shaft 302, the one or more surfaces 402, and other unlabeled components. The lever arm 108 includes an upper arm 404 and a lower arm 406.

The cavity 124 of the grilling apparatus is formed by one or more surfaces 402 of the grill body. The cavity 124 is an area or space within the grill body configured to accommodate various components, such as the heat tray 106 for the heat source, some of the lifting mechanisms (e.g., the lever arm 108, the hinge 110, the rod 112, and the push tab 114), and the food grate 104. FIG. 4 illustrates the boundaries of the cavity, defined by the surfaces 402, which may include the bottom, sides (e.g., front, rear, left, right, front-left, etc.), and potentially the top surface when the lid 102 is closed.

The push tab 114 may include a contact point 408 and a fixed point 410. The contact point 408 is coupled to the push shaft 302, receiving the converted linear force, while the fixed point 410 is fixedly coupled to a top end of the at least one lever arm 108. This configuration allows for the rotation of the push tab 114 in response to the linear force, which in turn raises the at least one lever arm 108, adjusting the vertical position of the heat tray 106 within the cavity 124.

The heat tray 106 may include at least one connection point 412 positioned along a plane that passes through a center of gravity (not shown in drawings) of the heat tray 106. This placement of the at least one connection point 412 ensures that as the at least one lever arm 108 lifts the heat tray 106, the heat tray 106 remains level, preventing the heat source from tilting and spilling and providing even distribution of heat to the food grate 104.

In some examples, the heat tray 106 includes one or more rims 414 configured to enclose a perimeter of the heat tray 106. The one or more rims 414 are configured to contain the heat source within the heat tray 106, preventing any charcoals, wood ships, or other heat-generating materials from shifting or falling off. In the example illustrated in FIG. 4, the one or more rims 414 include two connection points 412. The two connection points 412 are located along the plane that passes through the center of gravity of the heat tray 106, assuming that the center of gravity is located roughly in the middle of the heat tray 106. The two connection points 412 are connected to the second end of the at least one lever arm 108. Specifically, one connection point is rotatably coupled to the upper arm 404 and the other is rotatably coupled to the lower arm 406. The one or more rims 414 and the two connection points 412 ensure that the heat tray 106 is lifted and lowered in a balanced manner.

Each of the at least one lever arm 108 comprises an upper arm 404 and a lower arm 406. In the example illustrated in FIG. 4, the one or more rims 414 of the heat tray 106 include both an upper connection point 412 and a lower connection point 412, each rotatably coupled to the corresponding upper arm 404 or lower arm 406 of the at least one lever arm 108. The dual connection maintains the heat tray 106's level position during vertical adjustment. In some examples, the upper arm 404 and lower arm 406 are configured to slide relative to each other, allowing the upper connection point and the lower connection point to align mostly with the direction of the force of gravity. As a consequence, when the heat tray 106 is raised or lowered, the upper arm 404 and the lower arm 406 slide against one another, ensuring the heat tray 106 remains horizontal and stable.

In any given moment, the heat tray 106 may be in the raised position and the lowered position. The raised position and the lowered position are horizontally offset from each other, so the heat box 116 within the cavity is configured to accommodate the heat tray 106 in both positions. In the example illustrated in FIG. 4, the heat tray 106 is in the lowered position, resting against a left side of the heat box 116. When the heat tray 106 is lifted to its raised position, the heat trays 106 may come to rest against a right side of the heat box. Therefore, a pass-through of the heat box 116 is configured to be larger than a surface area of the heat tray 106, ensuring that the heat tray 106 can move freely between the lowered position and the raised position without obstruction.

In some examples, a heat shield is installed in between the heat box 116 and the one or more surfaces 402 of the grill body 126. The heat shield provides thermal insulation, maintaining heat within the heat box 116 for efficient cooking and reducing external surface temperatures of the grill body 126 for safety. In some examples, the heat shield is made of thermal insulating materials such as fiberglass, mineral wool, ceramic fiber insulation, and calcium silicate.

In some examples, the push shaft 302 includes the first portion 304 and the second portion 306. The first portion 304 is configured with interior threads, and the second portion 306 is configured with exterior threads compatible with the interior threads of the first portion 304 when detachably coupled together. Additionally, the first portion 304 may be constructed from or coated with materials that can withstand high temperatures without comprising structural integrity (e.g., stainless steel, cast iron, ceramic, silicon carbide, Inconel, and titanium) due to the close proximity to the heat source. The first portion 304 is configured to slide through the pass-through but is prevented from rotating relative to the pass-through. The second portion 306 is configured to rotate with the turning knob 120, and by rotating the second portion 306 relative to the first portion 304, the threated configuration allows length adjustment to the push shaft 302, thereby converting rotational force into linear force. The converted linear force is then applied to the push tab 114 via the contact point 408.

In some other examples, the push shaft 302 is coupled to the turning knob 120, configured with one or more exterior threads, and configured to rotate with the turning knob 120. The grilling apparatus further includes a threaded pass-through (not shown) disposed on one of the surfaces of the grill body 126 and through one of the walls of the heat box 116. The threaded pass-through includes one or more interior threads compatible with the one or more exterior threads of the push shaft 302. As the turning knob 120 and the push shaft 302 rotate, the push shaft 302 moves linearly towards or away from the heat box 116, effectively converting rotational force applied to the turning knob 120 into linear force exerted by the push shaft 302.

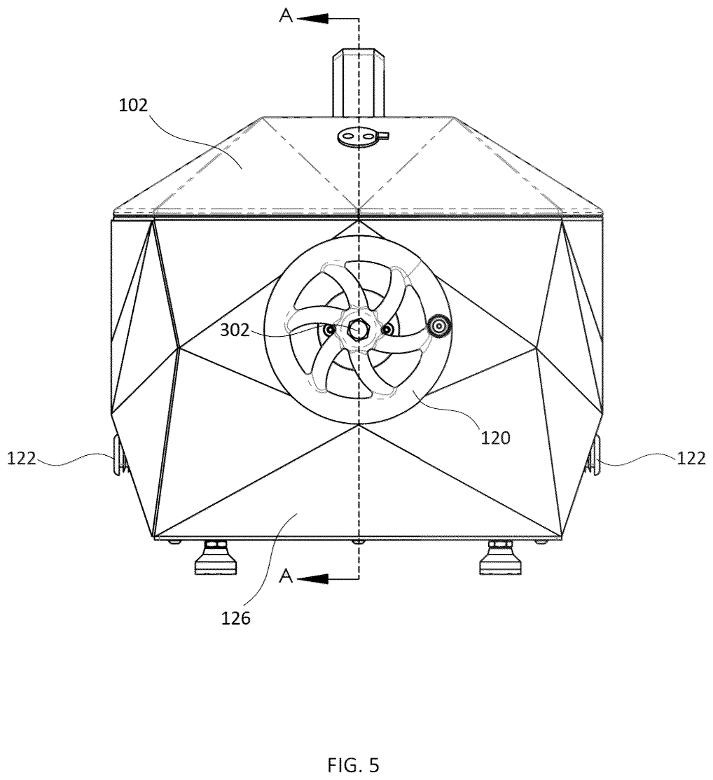

FIG. 5 is a side perspective view of the grilling apparatus, according to some examples. The grilling apparatus comprises the lid 102, the turning knob 120, the one or more bottom vents 122, the grill body 126, the push shaft 302.

The turning knob 120 is a rotary mechanism that involves a part rotating around a central axis (e.g., a push shaft 302). The turning knob 120 is configured to translate torque applied by the user manually or a motor into rotary motion. Some example turning knobs 120 include, but are not limited to: a lever, a crank handle, a handwheel, and a dial. The turning knob 120 may be disposed on one of the one or more surfaces 402 of the grilling apparatus. In some examples, the turning knob 120 may be coupled to an electric motor. The electric motor may be activated by a switch or a digital interface. In response to the electric motor being activated, the motor rotates the turning knob 120, providing rotational force. In some examples, the electric motor is programmed with preset positions for commonly used settings, offering convenience and repeatability.

At least one portion of the push shaft 302 is operatively coupled to the turning knob 120 in a manner that the push shaft 302 rotates with the turning knob 120 as the user or the motor rotates the turning knob 120.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

The following enumerated descriptions describe various examples of methods, machine-readable media, and systems (e.g., machines, devices, or other apparatus) discussed herein. Any one or more features of an example, taken in isolation or combination, should be considered as being within the disclosure of this application.

What is claimed is:

1. A grilling apparatus, comprising:
a grill body of the grilling apparatus;
a cavity formed by one or more surfaces of the grill body, the cavity being configured to fit a heat tray for disposing of a heat source; and
a lifting mechanism coupled to the heat tray for adjusting a position of the heat tray within the cavity, the lifting mechanism comprising:
a handle for receiving a rotational force;
a push shaft operatively coupled to the handle, the push shaft being configured to convert the rotational force to a linear force; and
at least one lever arm each comprising a first end and a second end, the first end operatively coupled to the push shaft, the second end operatively coupled to the heat tray, and
the at least one lever arm being configured to convert the linear force to a vertical force to lift the heat tray.

2. The grilling apparatus of claim 1, wherein the lifting mechanism further comprising:
a push tab comprising a contact point and a fixed point,
the contact point being operatively coupled to the push shaft to receive the converted linear force, and
the fixed point being fixedly coupled to a top end of the at least one lever arm such that in response to the contact point receiving the converted linear force, the push tab would be rotated, raising the at least one lever arm, thereby adjusting the vertical position of the heat tray.

3. The grilling apparatus of claim 1, wherein:
the heat tray comprises at least one connection point positioned along a plane passing through a center of gravity of the heat tray such that the heat tray remains level as the at least one lever arm lifts the heat tray.

4. The grilling apparatus of claim 1, wherein:
the heat tray comprises one or more rims configured to prevent the heat source from falling off, the one or more rims comprising at least one connection point positioned along a plane passing through a center of gravity of the heat tray such that the heat tray remains level as the heat tray is lifted; and
the at least one connection point being rotatably coupled to the at least one lever arm.

5. The grilling apparatus of claim 4, wherein the heat tray comprises a porous section, the porous section being configured to allow ash or remnants to fall through into a bottom of the cavity.

6. The grilling apparatus of claim 4, wherein:
the at least one lever arm each comprising an upper arm and a lower arm; and
the at least one rim comprises an upper connection point and a lower connection point,
the upper connection point being rotatably coupled to the upper arm,
the lower connection point being rotatably coupled to the lower arm, and
the upper connection point and the lower connection point being positioned along the plane passing through the center of gravity of the heat tray such that the heat tray remains level as the heat tray is lifted.

7. The grilling apparatus of claim 6, wherein the upper arm is configured to slide relative to the lower arm such that the heat tray remains level as the heat tray is lifted.

8. The grilling apparatus of claim 1, wherein the vertical position comprises a raised position and a lowered position, the raised position being horizontally offset from the lowered position; and
the grilling apparatus further comprises:
a heat box within the cavity of the grill body, the heat box being configured to accommodate the heat tray in both a raised position and a lowered position.

9. The grilling apparatus of claim 8, further comprising:
a heat shield installed between the one or more surfaces of the grill body and the heat box, the heat shield provides thermal insulation to maintain heat within the heat box and reduce external surface temperatures of the grill body.

10. The grilling apparatus of claim 1, wherein:
the push shaft comprises one or more exterior threads; and
the grilling apparatus further comprises:
a threaded pass-through disposed on one of the one or more surfaces of the grill body, the threaded pass-through comprising one or more interior threads matching the one or more exterior threads of the push shaft such that rotation of the push shaft causes linear movement of the push shaft toward the cavity, thereby providing the linear force.

11. The grilling apparatus of claim 1, further comprising:
a pass-through disposed on one of the one or more surfaces of the grill body; and
wherein the push shaft comprising:
a first portion comprising one or more exterior threads; and
a second portion comprising one or more interior threads matching the one or more exterior threads of the first portion, wherein the first portion is detachably coupled to the second portion such that rotation of the first portion relative to the second portion causes an adjustment in a length of the push shaft, thereby providing linear force.

12. The grilling apparatus of claim 11, wherein:
the pass-through has a non-circular cross-sectional shape; and
the second portion of the push shaft has a matching non-circular cross-sectional shape, wherein the non-circular cross-sectional shapes allow the second portion of the push shaft to slide linearly back and forth within the pass-through but prevent rotation of the second portion of the shaft relative to the pass-through.

13. The grilling apparatus of claim 1, further comprising:
a lid operatively supported by the grill body, wherein the lid is configured to retain heat within the grilling apparatus; and
a food grate operatively supported by one of the grill body, wherein the food grate is configured to support food for cooking.
